(19) United States
(12) Patent Application Publication
(10) Pub. No.: US 2024/0072482 A1
(43) Pub. Date: Feb. 29, 2024

(54) HIGH SPEED, RUGGEDIZED CONNECTOR

(71) Applicant: Amphenol East Asia Electronic Technology (Shenzhen) Co., Ltd., Shenzhen (CN)

(72) Inventors: Danren He, Shenzhen (CN); Xiang Wang, Shenzhen (CN); Yan-Bin Tan, Shenzhen (CN); Jinghe Feng, Shenzhen (CN); Cheng Dong, Shenzhen (CN)

(73) Assignee: Amphenol East Asia Electronic Technology (Shenzhen) Co., Ltd., Shenzhen (CN)

(21) Appl. No.: 18/169,962

(22) Filed: Feb. 16, 2023

(30) Foreign Application Priority Data
Aug. 30, 2022 (CN) 202222286484.3

(51) Int. Cl. H01R 13/502; H01R 13/533; H01R 13/6585

(52) U.S. Cl. CPC H01R 13/502; H01R 13/533; H01R 13/6585; H01R 13/6598; H01R 2201/26

(57) ABSTRACT

A modular connector with components that can be economically assembled to provide high signal integrity in a harsh environment. The connector includes an insulative housing bounding a mating interface, a conductive housing engaging a rear of the insulative housing and having tubes extending through the rear of the insulative housing to the mating interface, and lead assemblies disposed in respective tubes. The conductive housing has a channel extending from its top to its front. The insulative housing has a top extension extending beyond its rear, and a locking feature extending from its rear into the channel through the front of the conductive housing. A member is disposed in the channel and has opposite ends disposed in the top extension and locking feature of the insulative housing, respectively. Such a configuration prevents relative movement of components within the connector in a harsh environment and therefore provide more consistent signal paths.

### RELATED APPLICATIONS

This application claims priority to and the benefit of Chinese Patent Application Serial No. 202222286484.3, filed on Aug. 30, 2022. The contents of this application are incorporated herein by reference in their entirety.

### FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

An example of a system in which assemblies are connected through connectors is a modern automobile. For example, automotive vehicles include electronic control units (ECUs) for controlling various different vehicle systems, such as those for engine control, transmission control units (TCUs), security systems, emissions control, lighting, advanced driver assistance systems (ADAS), entertainment systems, navigation systems, and cameras. These assemblies may be connected over one or more vehicle networks formed with cables routed between these assemblies. To simplify manufacture of an automobile, the assemblies may be formed separately and then connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent the operation of the connector, it can cause electrical noise, which can interfere with the operation of the electronics joined through interconnects including connectors. Noise, for example, may result from relative movement of components within connectors, which can change the electrical properties of the connector. Variations in the electrical properties, in turn, can cause variation in the signals passing through the interconnect, which is noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those used to communicate data over an automobile network.

### BRIEF SUMMARY

Aspects of the present disclosure relate to high speed electrical connectors.

Some embodiments relate to an electrical connector. The electrical connector comprises a conductive housing; an insulative housing bounding a mating interface and engaging the conductive housing; and a member disposed in the conductive housing and passing through the insulative housing in at least one location.

In some embodiments, the member may pass through the insulative housing in two locations.

In some embodiments, the insulative housing may comprise a top, a rear, and a locking feature extending from the rear. The two locations may be at the top and the locking feature, respectively.

In some embodiments, the conductive housing may comprise a top, a front extending traverse to the top, and a channel extending from the top to the front. The rear of the insulative housing may engage the front of the conductive housing. The locking feature of the insulative housing may extend into the channel of the conductive housing. The member may be disposed in the channel of the conductive housing.

In some embodiments, the channel of the conductive housing may comprise a first opening at the top of the conductive housing and a second opening at the front of the conductive housing.

In some embodiments, the front of the conductive housing may comprise a pair of holes. The conductive housing may comprise a pair of tubes extending from the front in a mating direction and encircling cavities aligned with respective holes of the pair.

In some embodiments, the first opening may be wider than the second opening along a direction perpendicular to the mating direction.

In some embodiments, at least a portion of the channel may be disposed between the pair of holes.

In some embodiments, the electrical connector may comprise a shielding member spaced from the member and extending in a first plane parallel to a second plane that the member extends.

In some embodiments, the electrical connector may comprise a lead assembly comprising an insulative member and a conductive element at least partially disposed in the insulative member, the conductive element comprising a mating end extending out of the insulative member, a mounting end opposite the mating end and extending out of the insulative member, and an intermediate portion joining the mating end and the mounting end.

In some embodiments, the insulative member of the lead assembly may comprise a body holding the conductive element and a plurality of spacers extending backwards from the body and against the shielding member.

Some embodiments relate to a conductive housing for an electrical connector. The conductive housing may include a top comprising a first opening; a front extending transverse to the top, the front comprising a pair of holes extending therethrough, a second opening, and a channel connecting the second opening to the first opening of the top; and a pair of tubes extending from the front and encircling cavities aligned with respective holes of the pair.

In some embodiments, the channel may comprise a first portion joining the first opening, a second portion joining the second opening, and a third portion joining the first portion and second portion. The third portion may be the narrowest among the first, second and third portions in a direction that the front elongating.

In some embodiments, the pair of holes may be disposed on opposite sides of the third portion of the channel.

In some embodiments, the conductive housing may comprise a wall extending from a portion of the front that is between the pair of holes. The channel may extend into the wall.

In some embodiments, for each of the pair of tubes, the cavity may have an oval-shaped cross-section. Each of the pair of tubes may comprise a plurality of retention features disposed around the respective cavity.

In some embodiments, the conductive housing may comprise first and second sides extending from opposite edges of and transverse to the top and joining opposite edges of the front. The first and second sides may comprise first and second recesses.

In some embodiments, the conductive housing may comprise a wall extending from a portion of the front that is between the pair of holes and disposed between the first and second sides, the wall comprising a third recess. The top may comprise a fourth recess joining the first recess and the third recess and a fifth recess joining the third recess and the second recess.

In some embodiments, the third recess may have a U-shaped cross-section.

In some embodiments, the conductive housing may comprise a shielding member comprising edges disposed in the first, second, third, fourth and fifth recesses.

In some embodiments, the conductive housing may comprise a plurality of posts extending downwards; and one or more contact portions disposed between the plurality of posts.

In some embodiments, the conductive housing may comprise a member disposed in the channel and comprising an end extending out of the channel from the top.

Some embodiments relate to an electrical connector. The electrical connector may include a conductive housing described herein; and first and second lead assemblies disposed in the conductive housing, each of the first and second lead assemblies comprising an insulative member at least partially disposed in a respective one of the pair of tubes of the conductive housing and a conductive element separated from the conductive housing by the insulative member.

Some embodiments relate to an electrical connector. The electrical connector may include a lead assembly comprising an insulative member and a conductive element at least partially disposed in the insulative member; a conductive housing comprising a front and a tube extending from the front and encircling at least a portion of the insulative member of the lead assembly; and an insulative housing bounding a chamber with a top, a bottom, first and second sides and a rear, the rear engaging the front of the conductive housing and having a hole from which the tube of the conductive housing extends into the chamber, the first and second sides having extensions extending backwards beyond the rear, and the top having an extension extending backwards beyond the rear and joining the extensions of the first and second sides. The extensions of the sides may comprise projections towards the conductive housing. The extension of the top of the insulative housing may comprise a first hole.

In some embodiments, the insulative housing may comprise one or more guiding features extending into the chamber. The one or more guiding features may be asymmetrical.

In some embodiments, the insulative housing may comprise a latching feature extending from the top.

In some embodiments, the insulative housing may comprise a locking feature extending backwards from the rear, the locking feature disposed closer to the bottom than the top, the locking feature comprising a second hole at least partially overlapping with the first hole.

In some embodiments, the electrical connector may comprise a member comprising a first end, a second end opposite the first end, and an intermediate portion joining the first end and the second end. The first end of the member may be at least partially disposed in the first hole of the extension of the top of the insulative housing. The second end of the member may be at least partially disposed in the second hole of the extension of the locking feature of the insulative housing.

In some embodiments, for the member, the intermediate portion may be narrower than the first end, and the second end may be narrower than the intermediate portion.

These techniques may be used alone or in any suitable combination. The foregoing summary is provided by way of illustration and is not intended to be limiting.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an interconnection system where techniques described herein may be used.

FIG. 2A is a top, front perspective view of a connector that may be used as a board connector in the interconnection system of FIG. 1, according to some embodiments.

FIG. 2B is a bottom, rear perspective view of the connector of FIG. 2A.

FIG. 3 is an exploded perspective view of the connector of FIG. 2A.

FIG. 4A is a top, front perspective view of a conductive housing of the connector of FIG. 2A.

FIG. 4B is a bottom, front perspective view of the conductive housing of FIG. 4A.

FIG. 4C is a bottom perspective view of the conductive housing of FIG. 4A.

FIG. 4D is a cross-sectional perspective view of the conductive housing of FIG. 4A along the line marked “4D-4D” in FIG. 4A.

FIG. 4E is a cross-sectional perspective view of the conductive housing of FIG. 4A along the line marked “4E-4E” in FIG. 4A.

FIG. 5A is a front, side perspective view of a housing of the connector of FIG. 2A.

FIG. 5B is a rear, side perspective view of the housing of FIG. 5A.

FIG. 6A is a cross-sectional perspective view of the connector of FIG. 2A along the line marked “6A-6A” in FIG. 2A.

FIG. 6B is a cross-sectional perspective view of the connector of FIG. 2A along the line marked “6B-6B” in FIG. 2A.

### DETAILED DESCRIPTION

The Inventors have recognized and appreciated connector design techniques that enable the connectors that may be economically manufactured to support greater bandwidth through high frequency operation yet operate reliably in the harsh environment such as one presented by an automobile. Such a connector would be suitable for interconnecting assemblies in an automotive network, for example. These techniques may be applied in a modular connector system in which a set of components may be combined to form connectors in any of multiple configurations. The cost associated with manufacturing connectors of the types described herein may be reduced by designing the parts of the connectors to be modular. The connectors may be configured to prevent relative movement of components within individual connectors.

The Inventors have recognized and appreciated various techniques that may be applied to the components of the connector system to provide connections with high signal integrity (SI). The SI improvements may result from controlling the electrical properties of the signal paths through the connector and/or from configuring the connector to operate effectively, notwithstanding the rugged automotive environment in which the connector is used.

A connector may have one or more lead assemblies arranged in an array. For example, two lead assemblies may be disposed side-by-side and form a 1×2 array. As another example, four lead assemblies may be disposed in two rows and two columns and form a 2×2 array. Each lead assembly may include one or more conductive elements held by an insulative member. Each conductive element may include a mating end extending out of one end of the insulative member and configured to mate with a complementary component such as a receptacle terminal that may be connected to a cable, and a mounting end extending out of an opposite end of the insulative member and configured to be mounted to a complementary component such as a printed circuit board (PCB). In some embodiments, each lead assembly may be configured to carry one signal, whether as a single ended signal or as a differential signal. In the exemplary embodiments illustrated below, each lead assembly has a pair of electrical conductors suitable for carrying a differential signal.

A conductive structure may hold the lead assemblies and serve as a shield for the differential signals by having portions that bound individual lead assemblies. In some embodiments, the conductive structure may be a die cast conductive housing. In some embodiments, the conductive structure may have a top and a front extending traverse to the top.

The conductive housing may have features configured for securely mounting to a printed circuit board. The conductive structure may have, in some examples, posts extending downwards from the sides and/or the wall between the sides. The posts may be configured for inserting into corresponding receivers of a printed circuit board. In other examples press-fit hold downs may engage the printed circuit board at one end and the conductive housing at the other to secure it to the printed circuit board.

An insulative housing may establish a mating interface of the connector. The insulative housing may provide latching features and/or guiding features for securely mating with another connector such as a cable connector. In some embodiments, the insulative housing may bound a chamber with a top, a bottom, two sides and a rear. The rear may engage the front of the conductive structure and have holes from which the tubes of the conductive housing can extend into the chamber and the mating ends of the conductive elements can extend to the mating interface. The tubes of the conductive structure may have retention features such as projections disposed around respective cavities so as to provide interference with the rear of the insulative housing and prevent the conductive structure from moving with respect to the insulative housing.

Such a modular construction enables connectors to be economically manufactured in multiple configurations, as the lead assemblies, conductive housing and the insulative housing may be varied independently. The Inventors have recognized and appreciated techniques for reliable operation of such a connector, including good signal integrity for signals passing through the connector. Detachment of the conductive structure from the insulative housing could have negative effects, like allowing the mated connectors to partially or fully demate. Partial demating would impact signal integrity and full demating would prevent all operation of the connector. To prevent degradation of signals and other undesired effects, robust mechanical connection may be provided between the insulative housing and the conductive housing. A robust mechanical connection may be provided by a member that extends through one or more portions of the insulative housing and one or more portions of the conductive housing. Such a configuration may increase retention force between the conductive structure and the insulative housing.

The conductive housing, for example, may have a first exterior surface, and a portion of the insulative housing may overlay a portion of that first exterior surface. A member may pass through the portion of the insulative housing overlaying the first exterior surface and through the first exterior surface into the conductive housing. Alternatively or additionally, the conductive housing may have a second exterior surface with an opening through that surface. A portion of the insulative housing may project into that opening and a member may pass through portions of the conductive housing and through the portion of the insulative housing projecting through the opening. The first exterior surface, for example, may be the top of the conductive housing and the second exterior surface may be a front of the conductive housing.

In implementations in which a member passes through the insulative housing in more than one location, the connector may include multiple members, each pass through the insulative housing in one or a subset of the locations. Alternatively or additionally, the locations at which the member passes through the insulative housing may fall along a line, and a single member may extend through the insulative housing at multiple locations.

In some examples, the conductive structure may have a channel, and the member may be disposed in the channel. The channel may open at the top and front of the conductive structure, and the member may have an end at least partially extending above the top of the conductive structure and the other end at least partially aligned with the opening of the channel at the front of the conductive structure. In some example implementations, the member may be conductive. In other examples, the member may be a die cast member. In some embodiments, the member may be cut from a metal sheet.

The insulative housing may have features for receiving the ends of the member at least partially so as to prevent the insulative housing from moving with respect to the conductive housing. The insulative housing may have extensions extending backwards beyond the rear from the top and the sides, respectively. The top extension may have a hole for receiving the end of the member extending above the top of the conductive structure. The insulative housing may have a locking feature extending backwards from the rear and into the channel of the conductive housing through the opening at the front of the conductive housing. The locking feature may have a hole for receiving the other end of the member. Such a configurations prevent the conductive structure from moving with respect to the insulative housing. The side extensions may engage the sides of the conductive structure. The side extensions may have projections towards the sides of the conductive housing so as to further prevent the conductive structure from moving with respect to the insulative housing.

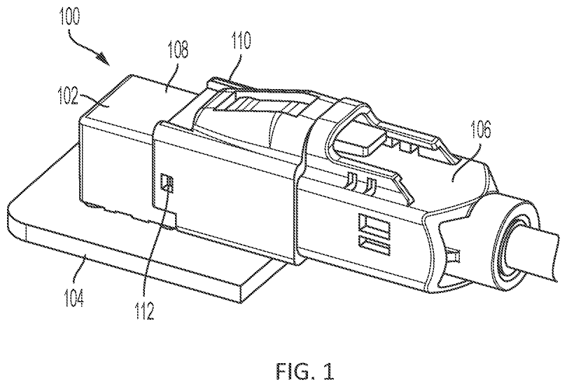

FIG. 1 shows an interconnection system 100 that may be used to make connections between assemblies in an automobile. The interconnection system 100 may have a board connector 102 mounted on a printed circuit board 104 and mated to a cable connector 106 that may be connected to another assembly such as another printed circuit board. The connectors 102 and 106 may provide interconnection between the printed circuit board 104 and this other assembly. In a harsh environment such as one that an automobile presents, the interconnection system 100 needs to provide high data rate transmission while sustaining vibrations. In the illustrated example, the connector 102 has a conductive housing 108 and an insulative housing 110. The conductive housing 108 and insulative housing 110 are connected through fixing features 112 on the outside of the conductive structure.

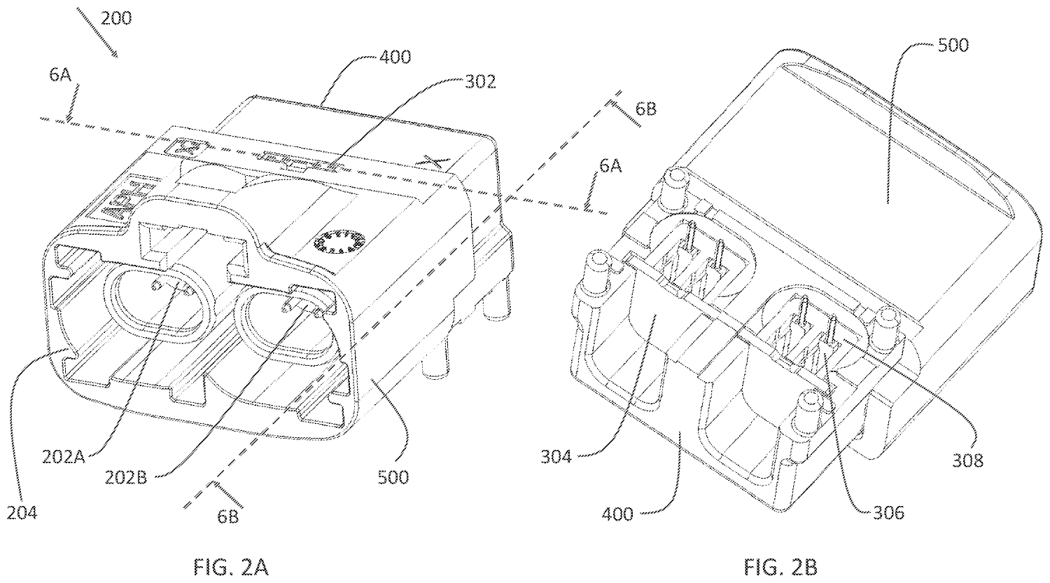

The Inventors have recognized and appreciated techniques to provide retention forces among components in a connector higher than that can be provided by the fixing features 112 and therefore provide more consistent signal conduction paths, which increases signal integrity at high frequency operation. FIGS. 2A-6B are an example of techniques as described herein integrated into a board connector 200. In this example, board connector 200 may include a pair of lead assemblies 202A and 202B disposed in a conductive housing 400, and an insulative housing 500 bounding a mating interface 204.

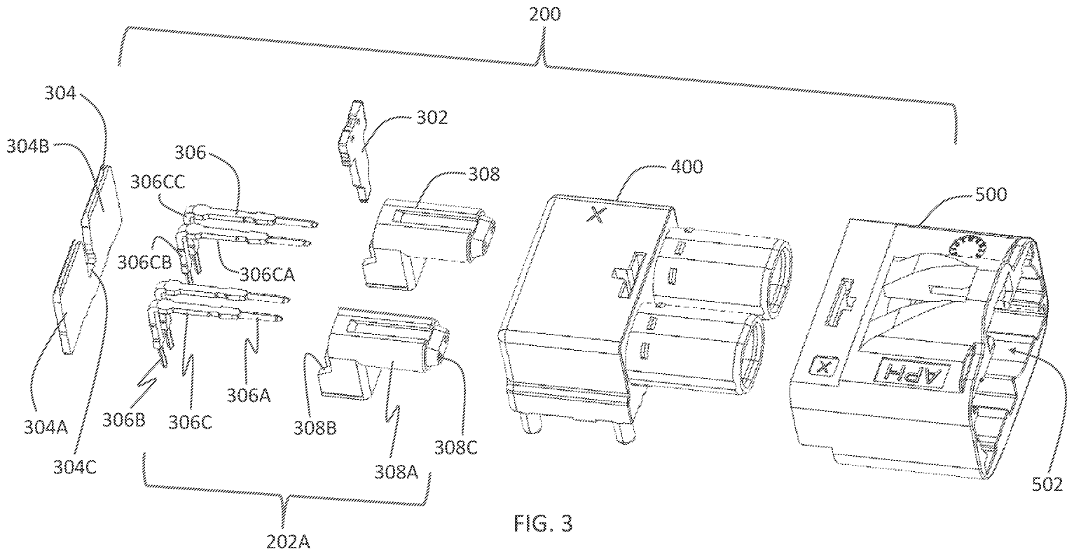

As shown in FIG. 3, each of the lead assemblies 202A and 202B may include a pair of conductive elements 306 at least partially disposed in an insulative member 308. Each conductive element 306 may include a mating end 306A, a mounting end 306B, and an intermediate portion 306C joining the mating end 306A and mounting end 306B. In the illustrated example, the intermediate portion 306C may include a first portion 306CA joining the mating end 306A, a second portion 306CB joining the mounting end 306B, and a third portion 306CC joining the first portion 306CA and second portion 306CB such that the first portion 306CA and second portion 306CB may extend in an angle (e.g., a right angle, an obtuse angle). The insulative member 308 may include a body 308A having openings 308C for the mating ends 306A of the conductive elements 306 extending therethrough, and spacers 308B extending backwards from the body 308A.

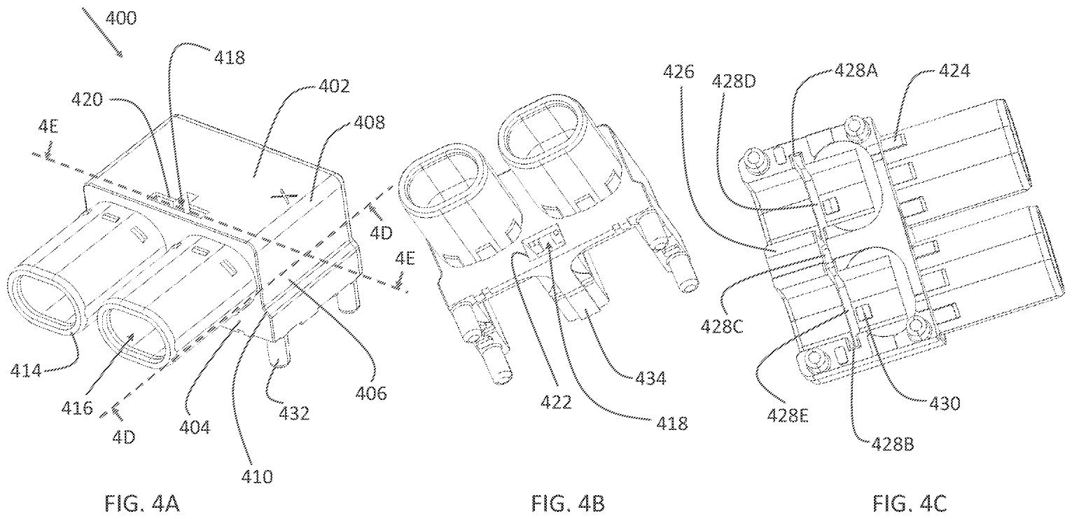

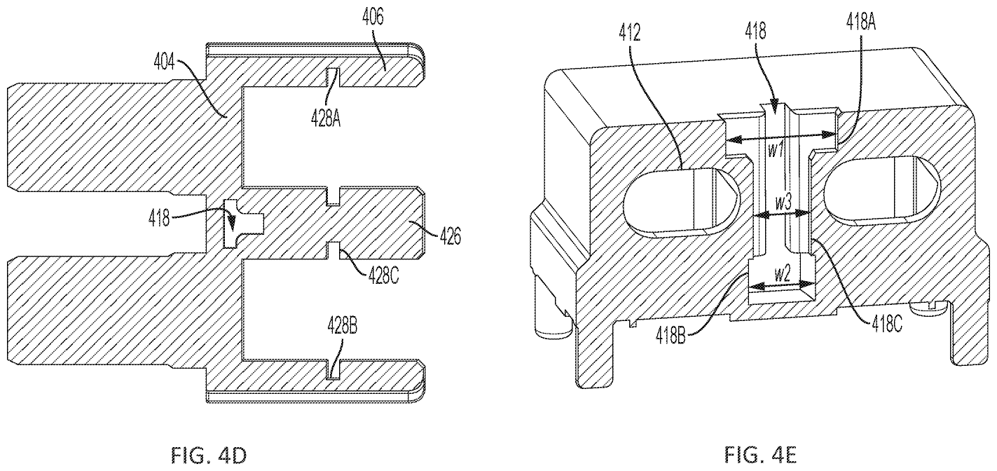

As shown in FIGS. 4A-4E, the conductive housing 400 may include a top 402 having an opening 420, a front 404 traverse to the top 402 and having an opening 422, and two sides 406 extending from opposite edges 408 of the top 402 and joining opposite edges 410 of the front 404. The front 404 may have a pair of holes 412. The conductive housing 400 may include a pair of tubes 414 extending from the front 404 in the mating direction and encircling respective cavities 416 aligned with respective holes 412 of the pair. Each cavity 416 may have an oval-shaped cross-section. The pair of lead assemblies 202A and 202B may be inserted into the pair of tubes 414. For each lead assembly, the tube 414 may enclose the mating ends 306A and at least the first portions 306CA of the intermediate portions 306C of the pair of conductive elements 306. Such a configuration enables the tubes 414 to enclose the mated contact portions between the pair of conductive elements 306 and complementary conductive elements of a mating connector and therefore provides shielding at the mating interface.

Referring back to FIG. 3, the connector 200 may include a shielding member 304. The shielding member 304 may include a first portion 304A and a second portion 304B connected to the first portion 304A. The first portion 304A and second portion 304B may be partially separated by a gap 304C. Although the second portions 306CB of the intermediate portions 306C of the conductive elements 306 may be exposed by an opening at the back of the conductive housing 400, the shielding member 304 may be configured to provide shielding from the back. The first portion 304A of the shielding member 304 may be disposed to the back of the lead assembly 202A. The second portion 304B of the shielding member 304 may be disposed to the back of the lead assembly 202B.

As shown in FIG. 4C, the conductive housing 400 may have a slot configured to receive the shielding member 304. A wall 426 may extend from a portion of the front 404 that is between the pair of holes 412 and be disposed between the sides 406. The sides 406 may have recesses 428A and 428B, respectively. The wall 426 may have a recess 428C. The top 402 may include a recess 428D joining the recess 428A of one of the sides 406 and the recess 426C of the wall 426, and a recess 428E joining the recess 428B of the other one of the sides 406 and the recess 426C of the wall 426. The recess 428A-428E may form the slot for receiving the shielding member 304. The recess 428C of the wall 426 may have a U-shaped cross-section configured for the gap 304C of the shielding member 304 to fit in. The top 402 may have projections 430 for preventing the shielding member 304 from moving with respect to the conductive housing 400.

The conductive housing 400 may have features configured for securely mounting to a printed circuit board. As illustrated, the conductive housing 400 may have posts 432 extending downwards from the sides 406. Alternatively or additionally, posts may extend downwards from the wall 426 and configured to be inserted into receivers such as holes of a printed circuit board. Contact portions 434 may be disposed between the posts 432. As illustrated, the contact portions 434 may be projections extending downwards from the sides 406 and/or the wall 426. In some embodiments, the contact portions 434 may be soldered to contact pads on the printed circuit boards. Such a configuration enables the conductive housing 400 to be connected to ground planes of the printed circuit board through the posts 432 and/or contact portions 434. The contact portions 434 may be shaped to have the largest possible contact area with the printed circuit board while not disturbing signal routing in the printed circuit board.

The conductive housing 400 may have a channel 418 configured to receive a member 302 (FIG. 3). The channel 418 may extend from the top 402 to the front 404 and configured to receive a member 302. The channel 418 may connect the opening 420 of the top 402 to the opening 422 of the front 404. As shown in FIG. 4E, the channel 418 may include a first portion 418A having a first width w1 in a direction perpendicular to the mating direction, a second portion 418B having a second width w2 in the direction perpendicular to the mating direction, and a third portion 418C joining the first portion 418A and second portion 418B and having a third width w3 in the direction perpendicular to the mating direction. The front 404 may elongate in the direction perpendicular to the mating direction. As illustrated, the first width w1 may be larger than the second width w2; the second width w2 may be larger than the third width w3. In some embodiments, the channel 418 may extend into the wall 426, which may assist in assembling the member 302 into and out of the channel 418.

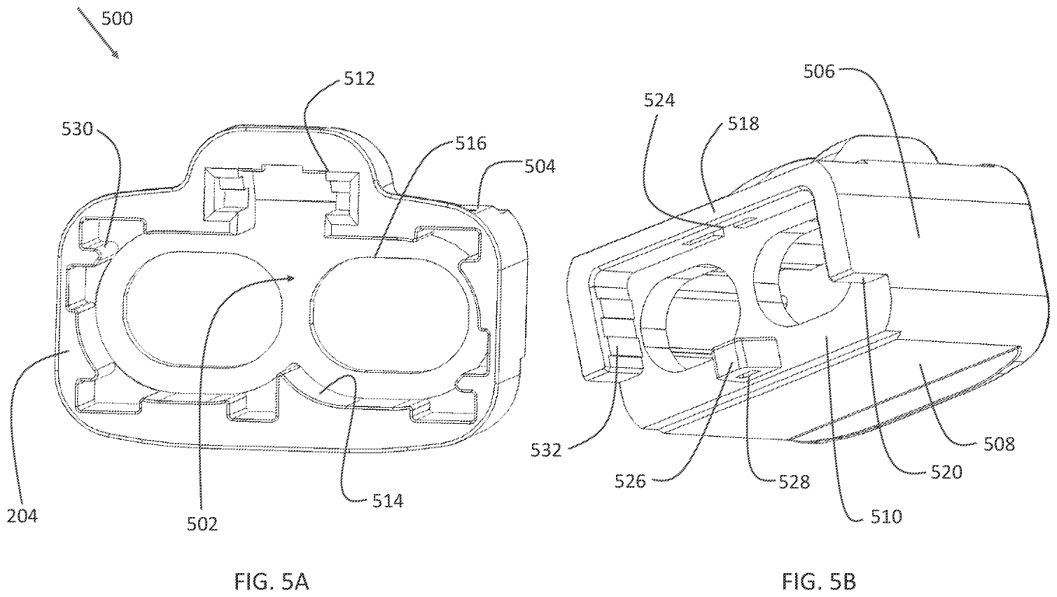

As shown in FIGS. 5A-5B, the insulative housing 500 may bound the mating interface 204. The insulative housing 500 may include a latching feature 512 for mating with a complementary feature of a mating connector. The insulative housing 500 may include a guiding feature 514 at the mating interface 204 and configured to ensure the mating connector is inserted in a correct orientation. The guiding feature 514 may have an outline 530 configured to bound the mating connector at least partially. As illustrated, the guiding feature 514 may be asymmetrical. Such configurations enable securely mating with the mating connector.

The insulative housing 500 may bound a chamber 502 with a top 504, a bottom 508, two sides 506 and a rear 510. The rear 510 may engage the front 404 of the conductive housing 400. The rear 510 may include a pair of holes 516 from which the pair of tubes 414 of the conductive housing 400 may extend into the chamber 502. As shown in FIG. 4C, the tubes 414 may have retention feature 424 disposed around respective cavities 416. When the tubes 414 are inserted into the chamber 502, the retention features 424 may engage portions of the rear 510 of the insulative housing 500 that are exposed by the holes 516 so as to prevent the conductive housing 400 from moving with respect to the insulative housing 500.

The insulative housing 500 may at least partially bound the conductive housing 400. As illustrated in FIG. 5B, the insulative housing 500 may include a top extension 518 extending from the top 504 and beyond the rear 510, and side extensions 520 extending from the sides 506 and beyond the rear 510. The side extensions 520 may have retention features 532 configured to engage the conductive housing 400. In the illustrated example, the retention features 532 are projections towards the sides 406 of the conductive housing 400.

The insulative housing 500 may have a locking feature 526 configured to be inserted into the channel 418 through the opening 422 of the front 404 of the conductive housing 400. The locking feature 526 may have a hole 528. The top extension 518 may have a hole 524 that is at least partially aligned with the hole 528 of the locking feature 526.

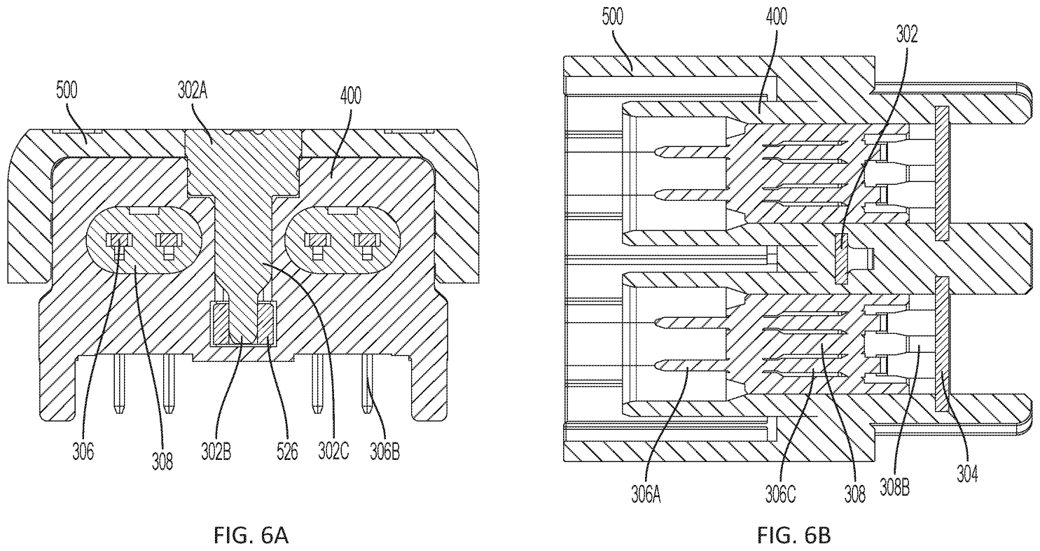

As shown in FIGS. 6A-6B, the member 302 may connect the insulative housing 500 and the conductive housing 400. The member 302 may include a first end 302A, a second end 302B, and an intermediate portion 302C joining the first end 302A and second end 302B. The first end 302A may extend above the top 402 of the conductive housing 400 and at least partially into the hole 524 of the top extension 518. The second end may at least partially extend into the hole 528 of the locking feature 526.

The member 302 may be sized and shaped to prevent the relative movement between the conductive housing 400 and the insulative housing 500. In the illustrated example, the intermediate portion 302C is narrower than the first end 302A; the second end 302B is narrower than the intermediate portion 302C. Such a configuration may prevent the member 302 from being accidently disengaged from the channel 418 and/or dislocation within the channel 418.

In some embodiments, housing components, such as the housing member 308 and insulative housing 500, may be dielectric members molded from a dielectric material such as plastic or nylon. Examples of suitable materials include, but are not limited to, liquid crystal polymer (LCP), polyphenyline sulfide (PPS), high temperature nylon or polyphenylenoxide (PPO) or polypropylene (PP). Other suitable materials may be employed, as aspects of the present disclosure are not limited in this regard.

In some embodiments, conductive components, such as conductive elements 306, member 302, and shielding member 304, may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

In some embodiments, conductive components, such as the conductive housing 400, member 302 and shielding member 304, may be conductive members molded from a conductive material such as a metal alloy. Examples of suitable materials include, but are not limited to, zinc, copper, aluminum, magnesium, lead, pewter, and tin-based alloys. Other suitable materials may be employed, as aspects of the present disclosure are not limited in this regard.

Although details of specific configurations of conductive elements and housings are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art.

For example, techniques for increasing the operating speed of a connector, under a harsh environment such as one that is presented by an automobile, are shown and described with reference to a board connector, it should be appreciated that aspects of the present disclosure are not limited in this regard, as any of the inventive concepts, whether alone or in combination with one or more other inventive concepts, may be used in other types of electrical connectors, such as cable connectors or any other suitable connectors.

In some embodiments, mounting ends were illustrated as solderable pins that are designed to be inserted into vias of printed circuit boards. However, other configurations may also be used, such as surface mount elements that are designed to fit within pads of printed circuit boards, press fit “eye of the needle” compliant sections, spring contacts, etc.

Such alterations, modifications, and improvements are intended to be within the spirit and scope of the invention. Accordingly, the foregoing description and drawings are by way of example only.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An electrical connector, comprising:
a conductive housing;
an insulative housing bounding a mating interface and engaging the conductive housing; and
a member disposed in the conductive housing and passing through the insulative housing in at least one location.

2. The electrical connector of claim 1, wherein:
the member passes through the insulative housing in two locations.

3. The electrical connector of claim 2, wherein:
the insulative housing comprises a top, a rear, and a locking feature extending from the rear, and
the two locations are at the top and the locking feature, respectively.

4. The electrical connector of claim 3, wherein:
the conductive housing comprises a top, a front extending traverse to the top, and a channel extending from the top to the front,
the rear of the insulative housing engages the front of the conductive housing,
the locking feature of the insulative housing extends into the channel of the conductive housing, and
the member is disposed in the channel of the conductive housing.

5. The electrical connector of claim 4, wherein:
the channel of the conductive housing comprises a first opening at the top of the conductive housing and a second opening at the front of the conductive housing.

6. The electrical connector of claim 5, wherein:
the front of the conductive housing comprises a pair of holes, and
the conductive housing comprises a pair of tubes extending from the front in a mating direction and encircling cavities aligned with respective holes of the pair.

7. The electrical connector of claim 6, wherein:
the first opening is wider than the second opening along a direction perpendicular to the mating direction.

8. The electrical connector of claim 6, wherein:
at least a portion of the channel is disposed between the pair of holes.

9. The electrical connector of claim 1, comprising:
a shielding member spaced from the member and extending in a first plane parallel to a second plane that the member extends.

10. A conductive housing for an electrical connector, comprising:
a top comprising a first opening;
a front extending transverse to the top, the front comprising a pair of holes extending therethrough, a second opening, and a channel connecting the second opening to the first opening of the top; and
a pair of tubes extending from the front and encircling cavities aligned with respective holes of the pair.

11. The conductive housing of claim 10, wherein:
the channel comprises a first portion joining the first opening, a second portion joining the second opening, and a third portion joining the first portion and second portion, and
the third portion is the narrowest among the first, second and third portions in a direction that the front elongating.

12. The conductive housing of claim 10, wherein:
for each of the pair of tubes, the cavity has an oval-shaped cross-section, and
each of the pair of tubes comprises a plurality of retention features disposed around the respective cavity.

13. The conductive housing of any of claim 10, comprising:
first and second sides extending from opposite edges of and transverse to the top and joining opposite edges of the front, wherein:
the first and second sides comprise first and second recesses.

14. The conductive housing of claim 13, comprising:
a wall extending from a portion of the front that is between the pair of holes and disposed between the first and second sides, the wall comprising a third recess, wherein:
the top comprises a fourth recess joining the first recess and the third recess and a fifth recess joining the third recess and the second recess.

15. The conductive housing of claim 10, comprising:
a member disposed in the channel and comprising an end extending out of the channel from the top.

16. An electrical connector, comprising:
a conductive housing of claim 10; and
first and second lead assemblies disposed in the conductive housing, each of the first and second lead assemblies comprising an insulative member at least partially disposed in a respective one of the pair of tubes of the conductive housing and a conductive element separated from the conductive housing by the insulative member.

17. An electrical connector, comprising:
a lead assembly comprising an insulative member and a conductive element at least partially disposed in the insulative member;
a conductive housing comprising a front and a tube extending from the front and encircling at least a portion of the insulative member of the lead assembly; and
an insulative housing bounding a chamber with a top, a bottom, first and second sides and a rear, the rear engaging the front of the conductive housing and having a hole from which the tube of the conductive housing extends into the chamber, the first and second sides having extensions extending backwards beyond the rear, and the top having an extension extending backwards beyond the rear and joining the extensions of the first and second sides, wherein:
the extensions of the sides comprise projections towards the conductive housing, and
the extension of the top of the insulative housing comprises a first hole.

18. The electrical connector of claim 17, wherein:
the insulative housing comprises one or more guiding features extending into the chamber, and
the one or more guiding features are asymmetrical.

19. The electrical connector of claim 17, wherein:
the insulative housing comprises a locking feature extending backwards from the rear, the locking feature disposed closer to the bottom than the top, the locking feature comprising a second hole at least partially overlapping with the first hole.

20. The electrical connector of claim 19, comprising:
a member comprising a first end, a second end opposite the first end, and an intermediate portion joining the first end and the second end, wherein:
the first end of the member is at least partially disposed in the first hole of the extension of the top of the insulative housing, and
the second end of the member is at least partially disposed in the second hole of the extension of the locking feature of the insulative housing.
